(19) United States
(12) Patent Application Publication
(10) Pub. No.: US 2002/0052761 A1
(43) Pub. Date: May 2, 2002

(54) Method and system for genetic screening data collection, analysis, report generation and access

(76) Inventors: Christopher T. Fey, Jacksonville, FL (US); Fred W. Fey, Ponte Vedra Beach, FL (US); Kathy M. Fleming, Ponte Vedra Beach, FL (US); John W. Franks, Jacksonville, FL (US); Paul S. Kasinski, Jacksonville, FL (US); Eduardo J. Balbona, Jacksonville, FL (US); Leah M. Nelms, Jacksonville, FL (US); Staci J. Presley, Jacksonville, FL (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 09/852,589

(22) Filed: May 10, 2001

Related U.S. Application Data
(63) Continuation-in-part of application No. 09/793,238, filed on Feb. 26, 2001.
(63) Continuation-in-part of application No. 09/792,101, filed on Feb. 23, 2001.
(60) Provisional application No. 60/203,291, filed on May 11, 2000.

(51) Int. Cl. G06F 17/60

(52) U.S. Cl. 705/2

(57) ABSTRACT

A genetic health data management system and method is provided. Specifically, the invention relates to a method, system, and computer program for collecting genetic screening and demographic data from clients, storing client's data and DNA/genetic material samples, processing and analyzing genetic testing data in conjunction with other relevant health data, generating custom reports, maintaining life-long health records and pre-populating data into user accessible personal health records.

### CROSS-REFERENCE TO RELATED APPLICATIONS

This application claims priority from U.S. provisional application, Ser. No. 60/203,291, filed May 11, 2000, U.S. patent application Ser. No. 09/793,238, filed Feb. 26, 2001, and U.S. patent application Ser. No. 09/792,101, filed Feb. 23, 2001, the disclosures of which are incorporated herein by reference in their entirety.

### FIELD OF THE INVENTION

The present invention relates to genetic health data management. Specifically, the invention relates to a method, system, and computer program for collecting genetic screening and demographic data from clients, storing clients' data and DNA samples, processing and analyzing genetic testing data in conjunction with other relevant health data, generating custom reports, maintaining life-long health records and pre-populating data into user accessible personal health records.

### BACKGROUND OF THE INVENTION

The diseases that kill most Americans are silent thieves, leaving few clues that they are robbing individuals of good health. By the time symptoms appear, the disease is often in an advanced, sometimes fatal, stage. Genetic screening can detect the presence of gene mutations that lead to debilitating and often fatal diseases many years before symptoms appear. Early detection of increased probability of disease affords the individual the greatest opportunity to prevent the condition or take a pro-active role in handling the condition in the most effective way possible to enhance quality of life.

“All human disease is genetic in origin,” said Nobel Laureate Paul Berg of Stanford University while addressing a medical symposium a few years ago. While Berg's statement was an exaggeration, research in genetics has confirmed that all human afflictions from cancer to psychiatric disorders and susceptibility to infection do have roots in our genes. “What we now need to do is find those genes,” according to James Watson, Nobel Prize winner for deciphering DNA's structure (www.hhmi.org/genetictrail/reading/read.htm).

Genetic research has been mapping genes and discovering links to genes for diseases that were only recently believed non-heritable. Parkinson's disease, first diagnosed in 1817, has no known cure at this time, yet more than a half-million Americans are afflicted with this neurodegenerative disease. By the time symptoms appear, including a noticeable tremor, muscular stiffness, and difficulty balancing and walking, the disease is full-blown. Just last year, a risk factor was mapped to mutations in chromosome 4. Alpha-synuclein, the protein produced by this chromosome, has been linked to several Parkinson's families. Interestingly, this is the same culprit recently identified as a constituent of Alzheimer disease plaques. Genetic researchers hope learning more about one disease will open doorways of understanding about the other, leading to an eventual cure or preventive treatment for both Parkinson's and Alzheimer's.

Another deadly degenerative disease, cystic fibrosis (CF), was first linked to genetics in 1982. CF is a fatal disorder that clogs the lungs and other organs with a viscous, sticky mucus that interferes with breathing and digestion. It is the most common lethal inherited disease among white children and young adults, attacking about 30,000 Americans. Until recently, most patients died before reaching the age of 30. Genetic testing for CF has been available since 1990 when testing could successfully identify up to 75% of all carriers, yet most of the 10 million Americans who carry an abnormal copy of the gene do not know that they are at risk of having children with the disease. That is at least partly because the National Institute of Health recommended waiting until 90 to 95% of all carriers could be identified before offering wide-spread genetic testing. Genetic testing is especially important for CF because both parents have to have an abnormal copy of the gene in order to produce a child with CF. If potential parents have access to a genetic screening test for CF, they could determine their risk and make a decision accordingly. Potential parents who discover they both carry the same gene mutation have the vital information needed to decide whether to look into other familial options, such as adoption, wait until a cure is closer, or have a child with CF. If they decide to proceed, they will be far better prepared for the added burden CF brings.

Cancer is the number two killer of adults in our country. Breast cancer, itself, is the “second major cause of cancer death in American women with an estimated 44,190 lives lost (290 men and 43,900 women) in the US in 1997,” according to the National Institute of Health. For approximately 14% of these cases and some forms of ovarian cancer, genetic predisposition is a major factor. Early detection, including genetic screening when indicated, often makes the difference between survival and fatality. Pre-cellular changes leading to cancer often occur in the body up to 10 years prior to the formation of a tumor. Yet most insurance carriers only pay for mammograms on a routine basis, which do not detect breast cancer until a tumor exists. In addition, mammograms have a high rate of false positives and can miss up to 20% of malignancies, especially in women with dense breast tissue or augmentation. Genetic screening can help a woman, in concert with her physician, determine if she should take preventive measures. If the initial genetic screen shows the existence of BRCA1 or BRCA2, further genetic screening can predict the type of breast cancer the client would be most likely to get. With over 26 different breast cancers that have varying levels of aggressiveness, patterns of appearance and recurrences as well as receptivity to focused treatments, genetic screening that pinpoints these factors allows the woman and her physician to optimize a preventive treatment program based on realistic probabilities. From positive lifestyle changes that decrease risk, such as a low-fat diet and regular exercise to preventive medications, such as Tamoxafen, or the more extreme step of a preventive double mastectomy, genetic screening provides the tools for informed decisions that save lives and reduce long term medical costs. Again, early detection and accurate risk assessment can lead to preventive treatment and positive lifestyle changes for those not yet dealing with cancer. For those with malignant tumors, early detection that includes genetic specifics when applicable, while tumors are small and localized greatly increases survival rates and quality of life for those survivors.

Two factors often influence the decision to undergo genetic screening. The first is the fear that if the clients go through their insurance companies to have the genetic screening, the insurance companies and employers could use that information to deny coverage or job opportunities. The second is the cost of the genetic screening itself when conducted by a private physician or hospital in an attempt to insure privacy. A complete genetic screening for breast cancer costs approximately $3500 when performed at a hospital, according to oncologist Troy Guthrie, MD, Shands-Jacksonville Medical Center. Insurance companies, faced with exploding costs, feel a fiscal responsibility to wait for irrefutable proof that a particular screening test saves a substantial number of lives before authorizing its use and have been slow to authorize any genetic tests. Typically, studies determining that level of proof take 10 to 15 years and are dependent upon funding to complete. Consumers, many of whom are aging baby-boomers, demand more control over their health care and more immediate access to potentially life-saving genetic screening in a secure, private environment.

In addition, our society is a mobile one. Families move an average of 8 times and no longer see the same general practitioner throughout their lives. Many adults travel on business and pleasure. There is a need for quick access to medical records should an emergency arise while away from home. Millions of Americans are covered under HMOs. If their primary care or specialty physicians leave the health care network, these consumers must transfer their records to newly-assigned physicians. Often transferring records involves a fee and an extended wait time, up to several weeks.

In addition, many physicians are compelled to get authorizations for most tests and may face stringent limitations when ordering tests. A-symptomatic patients are rarely given authorizations for many potentially life-saving genetic screening tests. If an insurance company authorizes the test, the patient may refuse to take the test out of fear that the information gathered will become available to insurance companies. Those companies could use it to deny coverage for the probability of a pre-existing condition or could charge higher premiums for life and disability coverage, claiming the risk is greater than the general population.

All of these factors point to a pressing need for a system and method that encourages wellness care through genetic health screening tests available directly to consumers at a reasonable cost as well as secure storage of the consumers' tests results and the DNA sample. There is also a need for the life-long storage of health records that is both secure and easily accessible by authorized persons. Further, there is a need for immediate access of those records by the client and attending physician. There is a need for custom reports generated at the time tests are performed and additional reports generated as needed. There is a need for an educational component to the reports that explains the results, the risk assessment, resources available to learn more and, possibly, lifestyle recommendations based on the results. An added benefit of this needed system, method and computer program is the compilation of tremendous data accumulated on a largely pre-symptomatic population. Such data can be used not only to analyze medical trends but can provide proof of the effectiveness of genetic screenings when accompanied by full explanations of the results and educational resources to learn more about potential conditions, prevention, wellness programs and treatment options.

While a number of patents have been issued dealing with medical databases and patient information, all have been solely for use by the medical community. Thus, the consumer does not experience greater control over individual health. In addition, the medical databases are primarily based upon data from symptomatic patients, rather than a population more reflective of the general population.

U.S. Pat. No. 6,014,630 to Jeacock & Nowak is comprised of a database system of various medical procedures, practices of individual physicians, methods followed by various medical facilities and a program to select desired ones for a particular patient with the capability of modification by the doctor. The program produces a personalized patient document that explains the procedure and follow-up care. While the document produced is educational for the patient, it is limited to one particular treatment by a specific doctor. The stated purpose is to protect the physician and facility from a malpractice suit due to lack of patient knowledge or understanding. It is not intended to increase a patient's control over health or to educate the patient on preventive care techniques to enhance wellness.

U.S. Pat. No. 6,151,581 to Kraftson, et al is for a system and method of collecting and populating a database with physician/patient data for processing to improve practice and quality healthcare. This invention seeks to build and administer a patient management and health care management database through the use of surveys to analyze the quality of care. While this invention seeks to improve patient care through the collection of data, the data relied upon is based solely upon a variety of surveys, thus is subjective rather than objective and scientific as genetic test results are. It is also intended for the exclusive use of the medical community, not the individual consumer. therefrom, storing the data and genetic samples, processing and analyzing the data, generating custom reports, maintaining heath data, and providing electronic user access to personal health records.

Features of the invention can be implemented in numerous ways, including as a system, a method, a computer site, or a computer readable medium. The invention preferably relies on a communications infrastructure, for example the Internet, wherein individual interaction is possible. Several embodiments of the invention are discussed below.

As a computer system, part of the invention generally includes a database and a processor unit. The processor unit operates to receive information (genetic, health and demographic) about an individual and to analyze the received information in conjunction with the statistical/known information (e.g., disease symptoms, risk factors, blood studies, screening factors) to generate customized detailed reports both for the individual and his physician. The reports may include print or electronic media.

The printed report preferably includes results from the screening with analysis and recommendations as well as a summary for the physician.

Part or all of the data can also be sent electronically or telephonically, with devices such as fax back, and maintained on a web server for confidential access with typical browsers. The data may be accessed or sent to medical practitioners or others at the discretion and direction of the consumer. The health and demographic data collected from the screening can pre-populate a life-long health record to avoid the need for the consumer to complete long medical information forms. The data may also be transmitted and viewed by other well known techniques such as email, interactive television, and the like. The computer site is preferably viewed with a client web browser as an HTML document through a web secure server communicating with an application server having a database associated therewith.

Screening test results may be used in conjunction with carefully formatted health risk assessment questionnaires which identify increased risks associated with social habits and behaviors as well as personal health history and familial history to better assess the individual consumer's risk and identify whether that individual may qualify to participate in and benefit from a specific clinical study. In addition, the aggregate data can be used to forecast trends and evaluate medical probabilities based on a population that more closely matches the general population. Questions in the health risk assessment should be based upon findings from prior scientific studies such as the Framingham study and/or reliable sources recognized by the medical community such as the American Heart Association and the American Cancer Association.

As a computer readable medium containing program instructions for collecting, analyzing and generating output, an embodiment of the invention includes computer readable code devices for interacting with a consumer as noted above, processing that data in conjunction with analytical information, and generating unique printed or electronic media for that consumer.

As screening data is collected from individual consumers, the aggregate of information may also be maintained and utilized for scientific research.

An object of the present invention is to provide a method of health data management, comprising the following steps, for each of a plurality of clients: (a) collecting demographic information from a client, the client having assigned thereto a unique client identifier; (b) conducting a medical screening on the client, wherein the screening comprises at least one genetic test; (c) storing results from said at least one test in a database (and storing the genetic samples); (d) analyzing results in conjunction with risk factors associated with the client; (e) generating a report for the client according to said analysis; and (f) pre-populating an electronic health record for remote access by the client. Another object would be to combine the results of a plurality of clients to provide aggregate information and providing access to the aggregate information.

As another object of the present invention, the step of storing results from the test in a database would include associating a unique identifier for each test taken by the client with the client identifier; and storing results wherein the results have assigned thereto a unique results identifier, the results identifier associated with the client identifier. Genetic sample may be stored in the same fashion by associating a unique identifier.

As another object of the present invention, the step of analyzing results in conjunction with risk factors would include, for each of a plurality of risk factors, assigning unique identifier for the risk factor, establishing a risk assessment question associated with the risk factor, inquiring of the client the risk assessment question, storing response to the risk assessment question, determining positive or negative risk factor based on the response. The report generated for the client according to the analysis would preferably include a screening summary having the test name, client results, and normal ranges; a detailed report having educational information for each of the tests conducted during client screening, said educational information comprising test name, client results, normal ranges, associated health risks, recommendations, and test protocols; and a physician's report having test name, client results, and normal ranges.

Another object of the invention includes populating an electronic health record for remote access by the client which has the steps of establishing a remotely accessible secure file for the client; automatically storing demographic information collected from the client; automatically storing test results for the client for each screening; allowing client to update file with additional data; and allowing client to control access to data by others.

In the present invention, the steps may be performed for each of a plurality of clients in an organization wherein the organization has assigned thereto a unique organization identifier and the organization identifier is associated with each client who is a member of the organization.

It is also an object of the present invention to provide a computer system for health data management, having input devices for collecting demographic information from a client, the client having assigned thereto a unique client identifier, receiving and storing results in a database from at least one genetic test conducted during a medical screening on the client; processing devices for analyzing results in conjunction with risk factors associated with the client and pre-populating an electronic health record for remote access by the client; and output devices for generating a report for the client according to the analysis.

It is also an object of the present invention to provide a computer readable media containing program instructions for outputting data from a computer system, the data being obtained from tables in a database associated with the computer system, the computer readable media having first computer program code for collecting demographic information from a client, the client having assigned thereto a unique client identifier; second computer program code for conducting a medical screening on the client, wherein said screening comprises at least one genetic test; third computer program code for storing results from said at least one test in a database; fourth computer program code for analyzing results in conjunction with risk factors associated with the client; fifth computer program code for generating a report for the client according to said analysis; and sixth computer program code for pre-populating an electronic health record for remote access by the client.

It is also an object of the present invention to provide a computerized storage and retrieval system for health data management comprising a data storage means for storing data in a relational database wherein the database comprises tables, each table having a domain of at least one attribute in common with at least one other table, the tables including: at least one table for storing demographic information pertaining to a client; at least one table for storing information pertaining to a risk assessment; at least one table for storing responses to the risk assessment; at least one table for storing risk factors for the risk assessment; at least one table for storing information pertaining to client screening; at least one table for storing common test information for tests that the client takes; and at least one table for storing genetic test results for tests that the client takes.

It is also an object of the present invention to provide a computer system for storing and retrieving health data having: a relational database for storing data comprising a plurality of interrelated tables wherein each table comprises an attribute having a common domain with an attribute of at least one other table in the database; and

means for collecting and storing demographic information from a client in said database, the client having assigned thereto a unique client identifier; means for conducting a medical screening on the client, wherein said screening comprises at least one genetic test; means for storing results from said at least one test in said database; means for analyzing results in conjunction with risk factors associated with the client; and means for generating a report for the client according to said analysis on the basis of the data stored in the relational database. Herein, the database comprises tables, the tables including: at least one table for storing demographic information pertaining to a client; at least one table for storing information pertaining to a risk assessment; at least one table for storing responses to the risk assessment; at least one table for storing risk factors for the risk assessment; at least one table for storing information pertaining to client screening; at least one table for storing common test information for tests that the client takes; and at least one table for storing genetic test results for tests that the client takes.

The advantages of the invention are numerous. First and foremost, the invention provides for a method by which consumers can take charge of their health, allowing them to receive and comprehend data from their screenings and maintain such data as a life-long health record. Linking the screening phase to the on-line health record provides the consumer with an easier means to begin and maintain such a health record by pre-populating a majority of the data fields from data already collected during the screening process. A resulting advantage is the ability to collect, analyze and maintain aggregate pre-symptomatic heath and demographic data for scientific research.

Other aspects and advantages of the invention will become apparent from the following detailed description taken in conjunction with the accompanying drawings, illustrating by way of example the principles of the invention.

All patents, patent applications, provisional applications, and publications referred to or cited herein, or from which a claim for benefit of priority has been made, are incorporated herein by reference in their entirety to the extent they are not inconsistent with the explicit teachings of this specification. The following patents are incorporated herein by reference: U.S. Pat. No. 6,154,726 to Rensimer, U.S. Pat. No. 6,151,581 to Kraftson, U.S. Pat. No. 6,148,297 to Swor, U.S. Pat. No. 6,144,837 to Quy, U.S. Pat. No. 6,022,315 to Iliff, U.S. Pat. No. 6,018,713 to Coli, U.S. Pat. No. 6,017,307 to Raines, U.S. Pat. No. 6,016,497 to Suver, U.S. Pat. No. 6,014,630 to Jeacock, U.S. Pat. No. 6,014,626 to Cohen, U.S. Pat. No. 6,002,915 to Shimizu, U.S. Pat. No. 5,995,937 to DeBusk, U.S. Pat. No. 5,991,731 to Colon, U.S. Pat. No. 5,991,730 to Lubin, U.S. Pat. No. 5,987,434 to Libman, U.S. Pat. No. 5,941,820 to Zimmerman, U.S. Pat. No. 5,924,074 to Evans, U.S. Pat. No. 5,890,129 to Spurgeon, U.S. Pat. No. 5,796,759 to Eisenberg, and U.S. Pat. No. 4,315,309 to Coli.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an overall system block diagram of a preferred embodiment of the present invention.

FIG. 2 is a system flow diagram of a preferred embodiment of the present invention.

FIG. 3 is a hardware diagram of a preferred embodiment of the present invention.

FIG. 4 is a flow diagram of the operation of a preferred embodiment of the present invention.

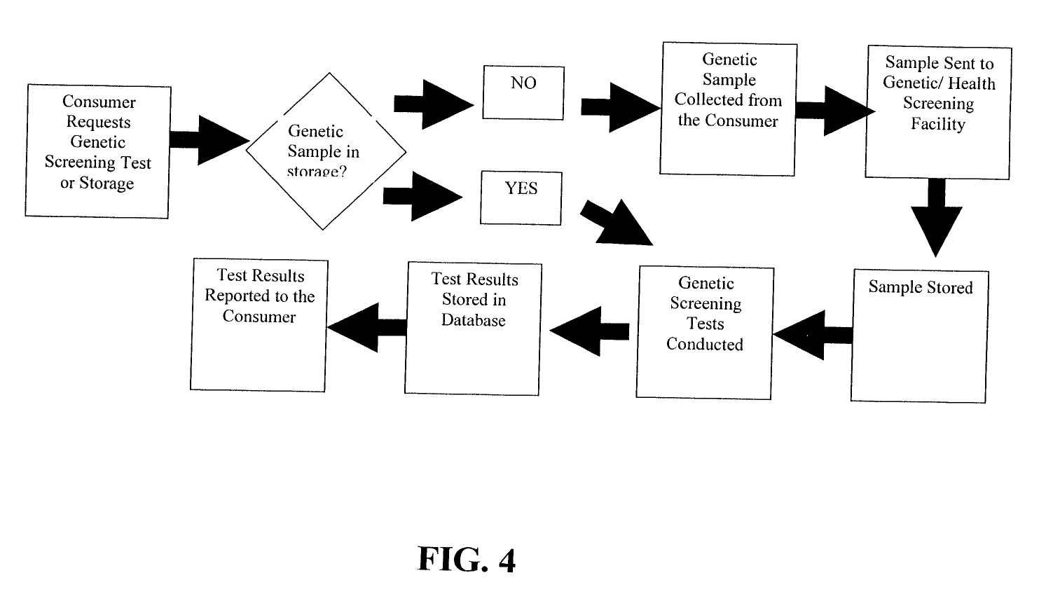

It should be understood that in certain situations for reasons of computational efficiency or ease of maintenance, the ordering of the blocks of the illustrated flow charts could be rearranged or moved inside or outside of the illustrated loops by one skilled in the art. While the present invention will be described with reference to the details of the embodiments of the invention shown in the drawing, these details are not intended to limit the scope of the invention.

### DETAILED DISCLOSURE OF THE INVENTION

Reference will now be made in detail to the embodiments consistent with the invention, examples of which are illustrated in the accompanying drawings. Wherever possible, the same reference numerals used throughout the drawings refer to the same or like parts.

The present invention solves the problems in the art by providing a system and method for screening clients, collecting genetic screening and demographic data therefrom, processing and analyzing the data, storing genetic samples, generating custom reports, maintaining heath data, and providing electronic user access to personal health records. Preferably, the invention is operated in conjunction with an interactive web site.

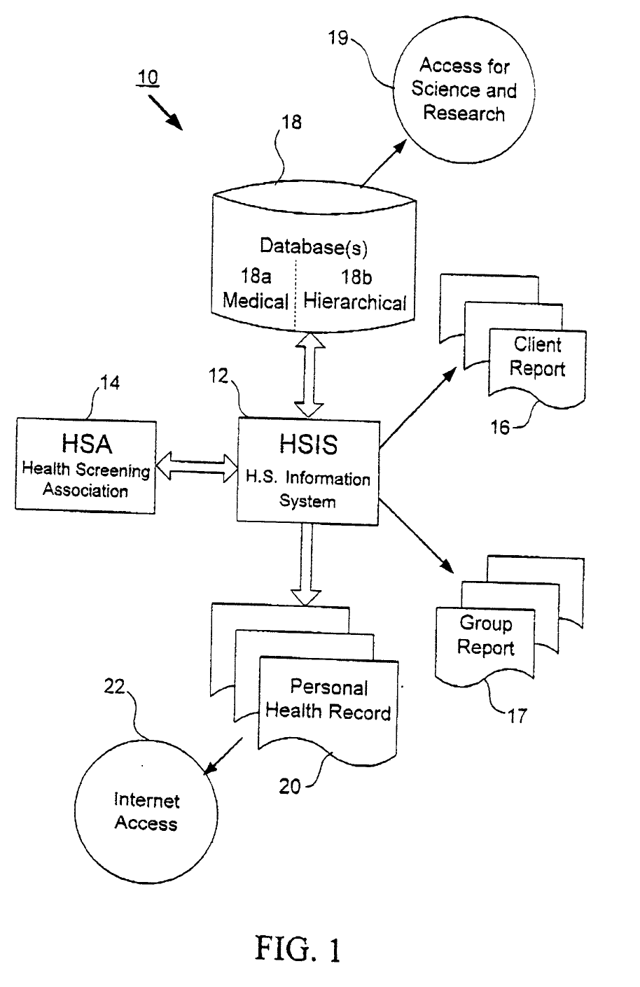

FIG. 1 shows an overall system block diagram of a preferred embodiment of the present invention. Central to the health data management system 10 is the Health Screening Information System (HSIS) 12 which is associated with a Health Screening Association (HSA) 14 to carry out the aspects of the present invention. The HSA may consist of various clinics, mobile units, screening facilities, and the like which provide for screening of clients, and collecting screening and demographic data therefrom. The HSA 14 communicates with the HSIS 12 for processing and analyzing the data. Custom reports are generated, both at the client level in the form of a client report 16 and at a collective level in the form of a group report 17. The system data is maintained in a database 18. This data may be accessed in aggregate form by various institutions and researchers 19 for scientific research. The system also provides for user access to electronic personal health records 20 via the Internet 22 or other electronic communication means (such as fax back system).

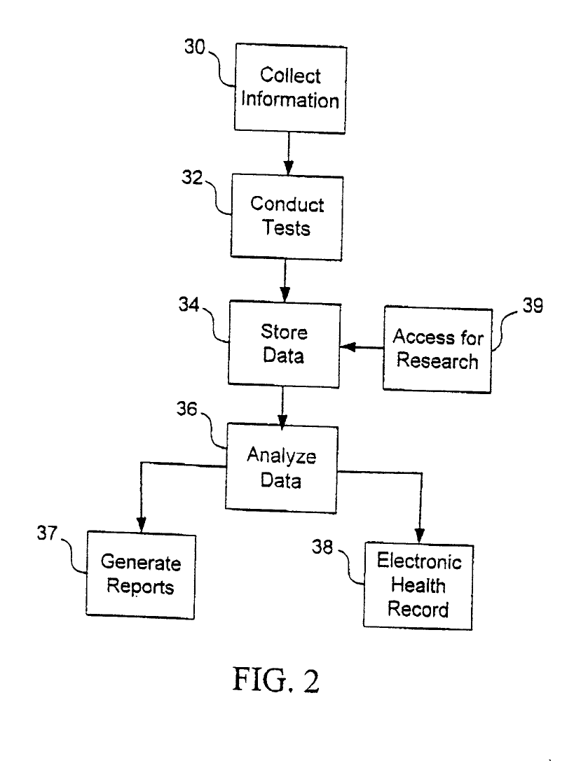

A brief overview of the system will now be described with reference to the process shown in FIG. 2. Initially, demographic information is collected about the consumer in step 30. Health screening tests are also conducted to collect health data in step 32. This data is input into the system in step 34 manually or directly from the screening devices. This health and demographic data is analyzed in step 36 in conjunction with known medical/statistical data (e.g., disease symptoms, risk factors, blood studies, screening factors). The system may utilize various algorithms, real-time learning and inference technology, profiling, pattern recognition learning algorithms, neural networks, and the like in order to correlate medical/statistical information with the collected data. The necessary medical/statistical information can be gathered from various known sources or acquired and continuously updated as the database acquires information from each new consumer.

After the software of the present invention analyzes the health screening and demographic data, the next step in the process is to generate in real-time a report for the individual consumer in step 37 (or for a group of consumers, e.g., a workplace). The personalized health record reviews individualized health risks and thoroughly explains test results with follow-up recommendations. Furthermore, a personalized health assessment is provided to determine further health risks.

The present invention also utilizes the consumer's information to pre-populate a “life-long health record” accessible on the Internet (or other communication means such as, but not limited to a fax back system) in step 38. This record stores the test results, plus medical history including allergies, medications, immunizations, insurance and physician information. From this site, consumers can store, retrieve and analyze personal medical data about themselves and their family in a secure environment. The site allows consumers to track their own health progress and tap into a huge library of medical information. Each time a consumer is screened, the results will be added to the site. The results may also be made available to consumers by other electronic communication means such as facsimile devices, e-mail, and the like.

The aggregate of collected health and demographic information is also maintained on the system. This information can be access in step 49 and utilized by doctors and researchers to discover trends, conduct scientific research, and study pre-symptomatic health data.

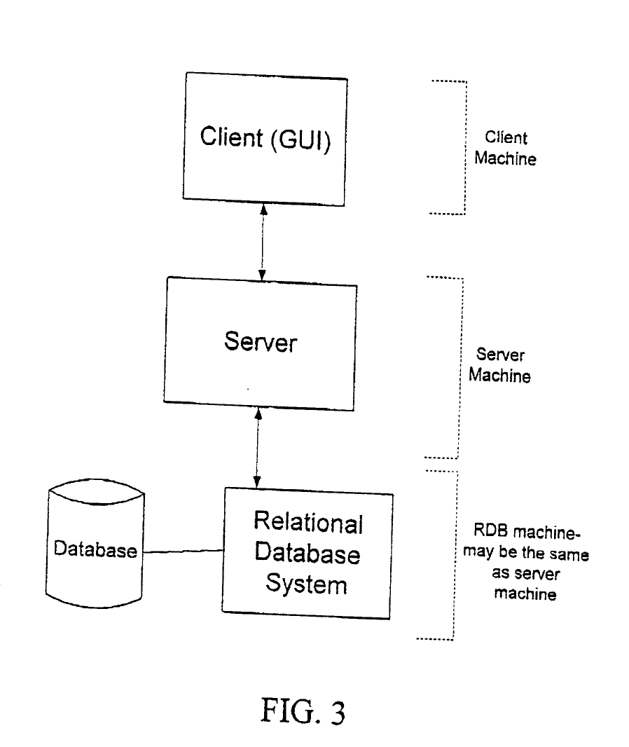

FIG. 3 shows the preferred architecture of the present invention. The system comprises at least two networked computer processors (client component(s) for input and server component(s)) and a database(s) for storing data. The computer processors can be processors that are typically found in personal desktop computers (e.g., IBM, Dell, Macintosh), portable computers, mainframes, minicomputers, or other computing devices. Preferably in the networked client/server architecture of the present invention, a classic two or three tier client server model is utilized. Preferably, a relational database management system (RDMS), either as part of the Application Server component or as a separate component (RDB machine) provides the interface to the database.

In a preferred database-centric client/server architecture, the client application generally requests services from the application server which makes requests to the database (or the database server). The server(s) (e.g., either as part of the application server machine or a separate RDB/relational database machine) responds to the client's requests.

More specifically, the input client components are preferably complete, stand-alone personal computers offering a full range of power and features to run applications. The client component preferably operates under any operating system and includes communication means, input means, storage means, and display means. The user enters input commands into the computer processor through input means which could comprise a keyboard, mouse, or both. Alternatively, the input means could comprise any device used to transfer information or commands. The display comprises a computer monitor, television, LCD, LED, or any other means to convey information to the user. In a preferred embodiment, the user interface is a graphical user interface (GUI) written for web browser applications.

The server component(s) can be a personal computer, a minicomputer, or a mainframe and offers data management, information sharing between clients, network administration and security. The Database Server (RDBMS—Relational Database Management System) and the Application Server may be the same machine or different hosts if desired.

The present invention also envisions other computing arrangements for the client and server(s), including processing on a single machine such as a mainframe, a collection of machines, or other suitable means. The client and server machines work together to accomplish the processing of the present invention.

The database(s) is preferably connected to the database server component and can be any device which will hold data. For example, the database can consist of any type of magnetic or optical storing device for a computer (e.g., CDROM, internal hard drive, tape drive). The database can be located remote to the server component (with access via modem or leased line) or locally to the server component.

The database is preferably a relational database that is organized and accessed according to relationships between data items. The relational database would preferably consist of a plurality of tables (entities). The rows of a table represent records (collections of information about separate items) and the columns represent fields (particular attributes of a record). In its simplest conception, the relational database is a collection of data entries that “relate” to each other through at least one common field.

### DESCRIPTION OF PREFERRED EMBODIMENT

For convenience, the description comprises three sections: the overview and architecture of the genetic screening method and storage apparatus; the process used with the individual consumer and the organization; and the storage of the demographic and genetic screening information for analysis and report generation.

I. Overview and Architecture of the Genetic Screening Method and Apparatus

Genetic health screening, offered directly to consumers without the need of a physician's referral or an insurance company's authorization, is at the center of the genetic screening collection and storage method. Appropriate genetic screening tests for this collection, storage, testing and reporting method are those not usually offered during an annual checkup. The purpose is to offer tests to a largely a-symptomatic population in order to find, track, and correct problems while the conditions are reversible before they may become chronic or fatal. In the preferred embodiment, genetic screening tests are conducted with FDA approved, cutting-edge technology by experienced health research professionals supervised by board-certified physicians at certified laboratories. Tests may be designed to increase the comfort level of the client by ensuring absolute anonymity and security on a DNA sample safely stored on-site that is not labeled in any traceable manner to the client. As the client wishes to determine whether there is any genetic predisposition or increased risk towards a disease or condition, the genetic test for that disease can be ordered and performed without any permission required from the client's insurance company or doctor. Results are reported only to the client, and with the client's permission, to a medical database designed to store and report test data in a secure, private environment. Clients' comfort levels may further be raised through personal and immediate attention without the typical long waiting periods many people experience when completing physician-ordered tests in other environments. In the preferred embodiment, patients are treated like preferred consumers whose time is valuable and right to know is paramount.

The health screening facility not only stores the DNA and offers the genetic tests, but also acts as both a buffer zone and a facilitator between the consumer and the community at large, including the medical research community and the consumer's employer or potential employer. The facility protects the consumer's privacy through careful storage in a database of screening test results and data, allowing access to the consumer's records only under the direction of the consumer and only in an anonymous manner that totally protects the consumer from any chance of personal information becoming public. At the same time, the facility matches helpful information, educational and clinical opportunities to the consumer, as long as the consumer permits the facility to do so, acting as a bridge between the medical community and the consumer. For instance, if the anonymous genetic screening test results reveal a close fit for a clinical study, the facility provides information on the study to the consumer. If the consumer expresses interest in pursuing the opportunity, the facility would release the consumer's contact information to the researchers. Thus, the consumer has the optimum opportunity to benefit from cutting-edge medical advancements without endangering personal privacy.

The health screening facility is responsible for the process of storing genetic tests and health risk assessment results. At the center of the architecture for this layer is a computer system with sufficient space to create and store demographic, diagnostic and genetic screening data, multiple informational tables and educational information. Test results and pertinent information from the tables may be included in a client test result report as well as a variety of other reports issued upon request. A medical database is created on the host computer. The medical database is comprised of two databases: the primary, relational database and a subsidiary, hierarchical database that contains all the tables of information, including but not limited to normal ranges of test results and risk assessments. Accurate tables populated with the most current information available from the most reliable medical resources are essential. The subsidiary database is more static and information is automatically pulled from there to populate specific fields in the reports generated in the primary database which operates in real-time.

Appendix A filed with U.S. patent application Ser. No. 09/792,101, incorporated herein by reference, is a CD containing all the source code and script used to create both databases. The script in the preferred embodiment is written in SQL and the source code in Visual Basic, but they may be written in any combination of IBM-compatible computer languages capable of creating both hierarchical and relational, object-oriented databases with communication embedded between them. Report software may also be utilized. In the preferred embodiment, Seagate Crystal Reports and Microsoft Excel are utilized, but any database management tool or system that is SQL compatible may be used including, but not limited to, Oracle and DB2. When information is pulled from SQL, it is put into Crystal Report for report generation and information analysis.

Additional workstations equipped with computers and printers may be used at point of service to enter demographic and screening data as well as generate appropriate reports, if desired. In the preferred embodiment, each computer at a permanent location has a shortcut on the desktop to the application that has a connection to the relational database. Computers in mobile units are not connected to the primary database. Instead they are connected to a mobile server and use a merge replication to ensure autonomous function without a direct connection to the primary database. A production server is required for the permanent workstations.

Replication of data in mobile units ensures the data can be accurately entered wherever the health event may be located. When merged, the data becomes part of the information in the relational database and it signals the subsidiary database, just as data entered from permanent locations does.

The subsidiary, hierarchical database is essentially a lookup database. In the preferred embodiment, List Manager is used. Hierarchical logic is incorporated in the program. The tables are composed of tasks, categories, tests, expected results, and the format of the expected results. Each test attribute has a unique identification number (ID#) which corresponds to the event in the List Manager.

Since the medical database contains consumers' health and information, strong security in the form of a firewall is mandatory. In the preferred embodiment, further security protection is incorporated. For example, each client may be assigned an unique 14-digit identification number, rather than a more traceable identifier such as a Social Security number.

An Intranet or business network (ITP connection) is required to support the database internally and an Internet web site accessible by all with several degrees of secured access is used to allow immediate, remote access to records and relevant educational information for both clients and physicians.

Because screening tests are offered directly to the consumer, educating the consumer to the availability and importance of early detection health screening is important. In the preferred embodiment, increasing consumer awareness is accomplished through a variety of methods, including participation in community-sponsored health fairs, marketing strategies and educational as well as scheduling information available on the web site which hosts the life-long health record.

II. Process Used with Individual Consumers

FIG. 2 is a flowchart showing one process for the genetic screening method. First, the consumer requests the genetic screening test or gets a genetic sample previously stored. If the sample is from storage, the tests are conducted, results stored/processed, and reports generated. Otherwise, the genetic sample is collected from the consumer, the sample is sent to the Genetic/Health Screening Facility for storage and/or testing. After the tests are conducted, the results are stored and reports generated.

IN one embodiment, individual consumers order DNA testing kits from the health facility, either over the phone, in person or online. Upon receipt of the kit, the consumer follows the directions in the kit, swabbing inside their cheek with the sterile material provided, then returns the kit to the health facility. The individual's demographic data is entered into the database along with the time and date the DNA was received. If genetic screening tests were ordered at the same time, information is also entered about the tests or test package desired. The cost for any tests ordered is automatically calculated and the health facility professional notifies the consumer, if the consumer has not included the correct amount. An alternative method could be offered at the web site wherein consumers could order genetic screening tests through a secured connection over the Internet.

In the preferred embodiment, the DNA is safely stored in a secure environment at the central location of the health facility that assures stabilization for a a specified number of years. When the consumer wishes to order a specific genetic test, the consumer pays a reasonable fee, the DNA sample on file is tested, and the information is entered into the database, along with any other screening tests, genetic or otherwise, that the consumer has completed at or through the facility. Samples may be sent to other genetic testing facilities for any tests not conducted at the health facility.

Before the initial test, individuals are asked to sign consent forms. The consent forms consist of four sections:

consent to take the tests

consent to have the results posted on a secure, privacy-protected life-long health record accessible with a web browser

consent to receive information in electronic and/or printed formats

consent to let their data be anonymously used in a statistical database to help forecast health trends and assess risk factors among a largely a-symptomatic population and to be informed of clinical trials and experimental treatments that may pertain to them, according to their test results.

In the preferred embodiment, all four consents would be given, but clients are given the tests as long as they sign the first portion of the consent form. Information including which consents was given and the date signed is entered into the database prior to any tests being performed. As a safeguard, the program is designed to prevent any further action being taken until the consent information is entered. At the point the consent information is entered, the computer automatically assigns a unique identifier to the client. The use of this identifier increases security. Many consumers are concerned that insurance carriers or employers may use information about health risks to deny coverage or employment opportunities. Avoiding the use of easily traceable numbers, such as social security numbers, helps maintain the consumer's right to privacy. Each time a client orders a new genetic screening test or comes into the health facility for other screening tests, the consent forms are reviewed, and any changes noted.

The test is performed at the research lab and the data is entered into the database in the most error-free way possible. In the preferred embodiment, the data is not entered by data entry personnel but by direct entry from the equipment or a smart card-type device. To further increase accuracy, additional accuracy checks may be instituted on a regular basis. For instance, another member of the facility staff not involved with the consumer's screening test may review the test results to certify that the results were entered correctly. In the preferred embodiment, two additional accuracy checks are routinely made to ensure the data is correct to the greatest degree possible. Such direct entry and accuracy checks avoid the risk of human error, such as reversing digits, and ensures a higher degree of accuracy.

Once all tests are completed at the research laboratory, the client may be given a report as soon as the results have been reviewed by a certified physician and released to the health facility. The printed report preferably includes results from the screening with analysis and recommendations as well as a summary for the physician. For example, the suggestion to eat a low fat diet and increase exercise could be passed on from the American Cancer Society to a client with the BRCA1 or BRCA2 gene since lowfat diets and regular moderate exercise are shown to decrease risk of breast cancer. The report may also suggest follow-up with the consumer's personal physician to discuss further preventive measures. In the preferred embodiment, only suggestions and recommendations widely accepted by the medical community and supported by well-respected authorities in the field, such as the American Diabetes Association, are made to consumers. However, under circumstances in which this invention is practiced by the consumer's personal physician, the preferred embodiment could include additional recommendations.

Part or all of the data can be sent electronically or telephonically, with devices such as fax back, and maintained on a web server for confidential access with typical browsers. The health and demographic data collected from the screening can pre-populate a life-long health record, which the consumer can bring to the physician, thus avoiding the tedious, time-consuming task of filling out long forms in the waiting room. The life-long health record may contain multiple screens, including but not limited to:

output screens containing complete reports of the genetic screening tests and health risk assessment results that can be reprinted as needed but not changed by the consumer

input screens for the consumer to add helpful information to complete the health history, from records of immunizations, medications previously or currently taken, and physician's contact information to search screens that allow the consumer to search for more information on a specific condition or to locate a new health care giver.

The data may also be viewed by other well-known techniques such as email, interactive television, and the like. The computer site is preferably viewed with a client web browser as an HTML document through a web secure server communicating with an application server having a database therewith. In the preferred embodiment, the client is assigned a password to use on the Internet web site which stores the test results, downloaded directly from the database. This allows immediate, secured access to the records by the consumer and appropriate physician. Additional reports can be printed and information can be updated to include other health records; however, no changes can be made to the test results. Other educational information can also be found on the web site and links are provided to additional helpful sites. Each time a client orders additional genetic testing, the database and life-long health record on the web site are automatically updated through the database.

The web site may also be used by consumers who have not had any genetic screening tests performed. Health-related educational information, facility information, interactive quizzes and activities as well as links to other helpful health web sites may be incorporated. The web site may generate additional clients for the genetic screening tests and increase awareness of the need for early detection, thus generating more health screening tests. This in turn increases the pool of statistics to be used for scientific analysis and appropriate candidates for clinical trials.

III. Storage of the Demographic and Genetic Screening Information for Analysis and Report Generation

The database has three essential purposes. It stores individual data for consumers to allow them to have greater control over their health and well-being as well as greater, immediate access to their health records. A report may be generated that gives comprehensive explanations of each test offered and charts which clearly show the normal ranges for each test. Preformatted and scripted, the report takes only a few minutes to print as the database pulls the information needed from List Manager and the results from the tests taken.

The knowledge that consumers can take part in comprehensive health screening including genetic testing without incurring penalties from their insurance companies or employers frees consumers to become better informed and armed to fight off disease through early intervention. Viewing and fully understanding concrete test results often provides the needed catalyst to seek treatment and/or make positive lifestyle changes. Being able to order genetic tests and access the results and life-long health records immediately through the Internet provides a greater measure of security while traveling, if a medical emergency should arise. Immediate accessibility to the client's life-long health record also makes changing doctors or seeking second opinions easier and faster than waiting for medical records from a physician's office. Automatic updating of the records every time genetic screening tests are taken provides a complete, convenient record that may span most of the consumer's lifetime, creating a more thorough record than is generally available. The additional information the consumer may add, such as the results of physician ordered tests or a record of medicine taken and any adverse effects could prove invaluable.

As genetic screening data is collected from individual consumers, the aggregate of information may also be maintained for scientific research. This invention amasses critical data on a largely a-symptomatic population by storing all the medical and demographic information without any personal identifiers. That information can help the medical community develop trend data and risk assessments on a far wider population than has generally been available before. Up until now, most databases have information on patients who already have symptoms, are battling full-fledged disease, or have lost the battle against the disease. In some cases, determinations of risk are based on a population that is largely deceased. Yet, we all know that people are living longer and healthier lives today. At the same time, some risk factors have increased. For instance, the United States has a greater percentage of Alzheimer patients than at any other time in the last century. Moreover, the disease is expected to increase as a large percentage of aging baby-boomers are expected to outlive previous generations. If new genetic information is not discovered that leads to new ways of combating Alzheimer's through scientific research and clinical trials, the United States could be looking at far greater instances of Alzheimer's disease in the next 20-40 years. Having more current information available to the medical community can translate into tremendous leaps forward in preventive care and early intervention.

Reports can be generated that detail risks according to location, age, gender and specific medical factors. Medical personnel can use that information to populate clinical trials with a cross-section of people at increased risk. To date, most clinical trials for preventive care rely upon advertising to the public in hopes of getting responses from those who are at greater risk. For instance, a large Tomaxofen study advertised for women who have had some family history of breast cancer. Researchers were forced to rely upon the accuracy of the women's memories, and, in some cases, stories repeated by family members but not experienced by the women, themselves, when choosing candidates for the study. With this invention, researchers will be able to choose candidates whose DNA contains the specific BRCA1 or BRCA2 genes related to increased risk of breast cancer.

A clinical trial based upon known evidence of risk factors could prove invaluable and produce more accurate results. For example, a clinical trial could use the more concrete criteria of at least 30% but not more than 45% calcified plaque in the coronary arteries to test medication for the prevention of heart attack. The database would generate a report based on the health screening of those participants who authorized information be released for clinical trials, and those people could be contacted directly by the medical personnel running the trial.

In addition, other reports can be generated, from those that show the source of business for the healthscreening center to those that delineate overall results from all participants by test. Results of these reports can be used to pinpoint areas or groups of people who may need further education about the importance of early detection and preventive care in addition to business forecasting. Example reports can list the normal, abnormal and total for each test for a specific period of time. They also can show the abnormal result percentage for each test. This data can be used for trending forecasts and immediate risk assessments.

It will be readily appreciated that the principles of the invention may apply to other computers applications, such as mainframes, minicomputers, network servers, supercomputers, personal computers, or workstations, as well as other electronics applications. Therefore, while the discussion herein focuses on a particular business method, it should be understood that the invention is not limited to the particular hardware designs, software designs, communications protocols, performance parameters, or application-specific functions disclosed herein.

It should be understood that the examples and embodiments described herein are for illustrative purposes only and that various modifications or changes in light thereof will be suggested to persons skilled in the art and are to be included within the spirit and purview of this application and the scope of the appended claims.

What is claimed is:

1. A method of health data management, comprising the following steps, for each of a plurality of clients:
(a) collecting demographic information from a client, the client having assigned thereto a unique client identifier;
(b) conducting a medical screening on the client, wherein said screening comprises at least one genetic test;
(c) storing results from said at least one test in a database;
(d) analyzing results in conjunction with risk factors associated with the client;
(e) generating a report for the client according to said analysis; and
(f) pre-populating an electronic health record for remote access by the client.

2. The method of claim 1 further comprising the step of combining the results of a plurality of clients to provide aggregate information and providing access to said aggregate information.

3. The method of claim 1 wherein the step of storing results from said test in a database comprises:
associating a unique identifier for each test taken by the client with said client identifier;
storing results wherein said results have assigned thereto a unique results identifier, said results identifier associated with said client identifier.

4. The method of claim 1 wherein the step of analyzing results in conjunction with risk factors comprises, for each of a plurality of risk factors, assigning unique identifier for said risk factor, establishing a risk assessment question associated with said risk factor, inquiring of the client said risk assessment question, storing response to said risk assessment question, determining positive or negative risk factor based on said response.

5. The method of claim 1 wherein the report generated for the client according to said analysis comprises:
a screening summary comprising test name, client results, and normal ranges;
a detailed report comprising educational information for each of said tests conducted during client screening, said educational information comprising test name, client results, normal ranges, associated health risks, recommendations, and test protocols; and
a physician's report comprising test name, client results, and normal ranges.

6. The method of claim 1 wherein the step of populating an electronic health record for remote access by the client comprises:
establishing a remotely accessible secure file for said client;
automatically storing demographic information collected from said client;
automatically storing test results for said client for each screening;
allowing client to update file with additional data;
allowing client to control access to data by others.

7. The method of claim 1 wherein said steps are performed for each of a plurality of clients in an organization wherein said organization has assigned thereto a unique organization identifier and said organization identifier is associated with each client who is a member of the organization.

8. A computer system for health data management, comprising:
input means for collecting demographic information from a client, the client having assigned thereto a unique client identifier, receiving and storing results in a database from at least one genetic test conducted during a medical screening on the client;
processing means for analyzing results in conjunction with risk factors associated with the client and pre-populating an electronic health record for remote access by the client; and
output means for generating a report for the client according to said analysis.

9. A computer readable media containing program instructions for outputting data from a computer system, the data being obtained from tables in a database associated with the computer system, said computer readable media comprising:
first computer program code for collecting demographic information from a client, the client having assigned thereto a unique client identifier;
second computer program code for conducting a medical screening on the client, wherein said screening comprises at least one genetic test;
third computer program code for storing results from said at least one test in a database;
fourth computer program code for analyzing results in conjunction with risk factors associated with the client;
fifth computer program code for generating a report for the client according to said analysis; and
sixth computer program code for pre-populating an electronic health record for remote access by the client.

10. A computerized storage and retrieval system for health data management comprising a data storage means for storing data in a relational database wherein the database comprises tables, each table having a domain of at least one attribute in common with at least one other table, said tables comprising:
at least one table for storing demographic information pertaining to a client;
at least one table for storing information pertaining to a risk assessment;
at least one table for storing responses to the risk assessment;
at least one table for storing risk factors for the risk assessment;
at least one table for storing information pertaining to client screening;
at least one table for storing common test information for tests that the client takes; and
at least one table for storing genetic test results for tests that the client takes.

11. A computer system for storing and retrieving health data comprising:
a relational database for storing data comprising a plurality of interrelated tables wherein each table comprises an attribute having a common domain with an attribute of at least one other table in the database; and
means for collecting and storing demographic information from a client in said database, the client having assigned thereto a unique client identifier;
means for conducting a medical screening on the client, wherein said screening comprises at least one genetic test;
means for storing results from said at least one test in said database;
means for analyzing results in conjunction with risk factors associated with the client; and
means for generating a report for the client according to said analysis on the basis of the data stored in the relational database.

12. The computer system of claim 11, wherein the database comprises tables, said tables comprising:
at least one table for storing demographic information pertaining to a client;
at least one table for storing information pertaining to a risk assessment;
at least one table for storing responses to the risk assessment;
at least one table for storing risk factors for the risk assessment;
at least one table for storing information pertaining to client screening;
at least one table for storing common test information for tests that the client takes; and
at least one table for storing genetic test results for tests that the client takes.
